(19) United States
(12) Patent Application Publication
(10) Pub. No.: US 2021/0129395 A1
(43) Pub. Date: May 6, 2021

(54) Thermoplastic Composite Braided Preforms for Elongated Structural Profiles and Methods for Manufacture of Same

(71) Applicant: TSC, LLC, Mojave, CA (US)

(72) Inventors: Rob Sjostedt, Tehachapi, CA (US); Steve Slaughter, Lancaster, CA (US); Paul Nicholas, Burbank, CA (US)

(73) Assignee: TSC, LLC, Mojave, CA (US)

(21) Appl. No.: 17/090,029

(22) Filed: Nov. 5, 2020

Related U.S. Application Data
(60) Provisional application No. 62/931,642, filed on Nov. 6, 2019.

(51) Int. Cl. B29C 43/18; D04C 1/06; D04C 1/04; B29B 11/14

(52) U.S. Cl. CPC B29C 43/18; D04C 1/06; B29K 2307/04; B29B 11/14; D10B 2505/02; D04C 1/04

(57) ABSTRACT

Thermoplastic composite preforms for continuous fiber thermoplastic composite structural profiles and a system and method of manufacture for structural profiles utilizing thermoplastic filaments comingled with high strength fibers such as carbon fibers and braided into complex preforms suitable for automated press forming is disclosed. Utilizing flexible preforms in lieu of conventional rigid thermoplastic pre-preg material forms allows for manufacture of complex shapes, including both straight and curved shapes by an automated process.

### CROSS-REFERENCE TO RELATED APPLICATION

This application claims priority under 35 USC Section 119(e) to co-pending U.S. Provisional Patent Application No. 62/931,642 filed on Nov. 6, 2019, the entire disclosure of which is incorporated herein by reference.

### FIELD OF THE INVENTION

This invention relates generally to thermoplastic composite braided preforms for structural profiles and a system and method for the manufacture of thermoplastic composite structural profiles.

### BACKGROUND OF THE INVENTION

Structural profiles such as I-beams, channels, hat sections, angles, tee sections, and Pi, or π, sections are commonly used as stringers, skin stiffeners, and joining elements in aircraft and other lightweight vehicle construction. In conventional metallic airframe and vehicle structures, these profiles are typically extruded from aluminum and used either straight or formed to fit the structure.

Lightweight composite materials such as carbon fiber and epoxy offer an increase in strength and reduction in weight for stiffeners and joining elements in aerospace, flight, and other vehicle applications. Thermoplastic matrix composites are also attractive because of the potential for rapid non-autoclave processing and inherent toughness of the materials. However, the current state of the art for composites is to laminate plies of thermosetting pre-preg materials in tools, vacuum bag for consolidation, and cure in an oven or autoclave.

Aerospace grade thermoplastic composite materials have an inherent manufacturing and cost challenge to making complicated, small cross section, elongated structural profiles because the materials are stiff and must be heated locally to bend them around sharp corners during lay-up of the complex structural shapes.

Thermoplastic materials such as unidirectional tape and woven cloth are stiff and have no tack, so they are also difficult to make into complex preforms. For example, if a +/−45 degree ply, which is when the materials are at about ninety degrees relative to each other, is formed around the corners of a tee section then the stiff conventional material must be heated to melt the matrix resin and form the material around the corners of the structural shape.

The manufacture of long, complex cross section structural profiles using conventional thermoplastic pre-preg materials is also time consuming, difficult, and costly. Conventional pre-preg thermoplastic uni-directional tapes also cannot be bent into curved shapes when used as axial reinforcements. Even when slit or cut to narrow widths, unidirectional tape has too much stiffness to make laterally curved parts without buckling the fibers. Also, if there are layers of conventional thermoplastic pre-preg tape then the layers must slip with respect to each other before forming a curved shape or they will buckle.

Therefore, this invention and disclosure provides flexible thermoplastic composite braided preforms for structural profiles and an improved method to manufacture thermoplastic composite structural profiles utilizing flexible preform tubes in lieu of conventional rigid thermoplastic pre-preg material forms.

### BRIEF SUMMARY OF THE INVENTION

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

This invention and disclosure provides thermoplastic composite braided preform tubes for manufacturing structural profiles and an improved method to manufacture thermoplastic composite structural profiles utilizing the flexible braided preform tubes in lieu of conventional rigid thermoplastic pre-preg material forms.

A braided preform tube is made from carbon fiber commingled with thermoplastic polymer filaments and braided into a tube shape which provides the ability to make elongated thermoplastic composite structural profile shapes that are either straight or curved by an automated process. Because the braided preform tube is flexible it can be produced in long lengths and rolled up on a spool, which facilitates automated step molding of structural profiles.

The braided preform tube is subsequently used as the preform for manufacturing finished structural profiles shapes such as flat beams, I-beams, channels, hat sections, angles, tee sections, and pi sections. Variations in the braid circumference and the incorporation of unidirectional comingled tow in the braiding process can create braided preform tubes suitable to make elongated structural profile shapes with optimized fiber architecture.

One or more braided preform tubes can also be inserted into a single braided tube to make thicker profiles although this can only be done for short lengths of braid and is not suitable for continuous automated step-forming. However, one or more braided preform tubes can be layered to create more material thickness and this approach can be utilized in continuous automated step-molding.

The desired structural profile shape is produced by heating the segmented tooling until the thermoplastic filaments melt, and forming and compressing the braided preform tube in segmented tooling of the appropriate shape. The thermoplastic filaments melt, flow, and form a polymer matrix that surrounds the carbon filaments. The segmented tooling is then cooled to a temperature below the melting point of the thermoplastic, at which time the structural profile is removed from the segmented tooling.

In an alternative embodiment, the braided preform tube by itself can be heated to above the melt point of the thermoplastic filaments and then mechanically drawn into the segmented tooling. The segmented tooling is then closed to form and consolidate the structural profile with the segmented tooling at a lower temperature than the melt point of the thermoplastic filaments. In this embodiment, it is not necessary to significantly heat the segmented tooling, and the segmented tooling can act as a heat sink to cool the structural profile.

Trimming the edges of the structural profile is time consuming, creates dust and debris that is both an environmental and health hazard and can lead to scrap parts if done incorrectly. It would be desirable to mold the part net to shape with no edge trim required. Therefore, another embodiment of this invention and disclosure is to mold the structural profiles using commingled braided preform tubes in such a manner that edge trim is not required.

In an alternative embodiment that can be used in combination with other embodiments herein, it is also possible to introduce axial zero-degree commingled carbon and thermoplastic filament tow in the braiding process for either the full circumference of the braided preform tube or a selected portion of the braided preform tube.

As a further alterative embodiment that can be used in combination with other embodiments herein, added structural strength without excessive weight is built into the structural profile by incorporating one or more pultruded rods into the braided preform tube to stiffen flanges of a structural profile. In one embodiment, pultruded rods can be unidirectional carbon fibers with a co-mingled thermoplastic matrix as a “bead” on the flange of the structural profile.

As a further alterative embodiment that can be used in combination with other embodiments herein, a small amount of axial tow can be incorporated into the braided preform tube at appropriate points to use as drawstrings to aid in locating the braided preform tube in the segmented tooling and holding it in position while the segmented tooling is closed.

In a further alterative embodiment that can be used in combination with other embodiments herein, creating a flexible braided preform tube allows for automated processing with a step-molding process using a step molding machine.

Accordingly, one or more embodiments of the present invention overcomes one or more of the shortcomings of the known prior art.

For example, in one embodiment, a method for the manufacture of a structural profile comprises providing a plurality of comingled structural fibers; braiding the plurality of comingled structural fibers into a braided preform tube; inserting the braided preform tube into a segmented tooling; heating the segmented tooling to melt the braided preform tube; applying pressure to the segmented tooling to form and consolidate the braided preform tube into a structural profile; cooling the structural profile; and removing the structural profile from the segmented tooling.

In this embodiment, the method can further comprise: wherein the plurality of comingled structural fibers comprises a plurality of carbon fibers and a plurality of thermoplastic polymer filaments; inserting a pre-pultruded rod into the braided preform tube; securing the braided preform tube in the segmented tooling using at least one drawstring; inserting a zero degree axial tow into the braided preform tube; wherein the segmented tooling forms the structural profile into a hat-shape; wherein the segmented tooling forms the structural profile into an I-shape; wherein the segmented tooling forms the structural profile into a Pi-shape; wherein the segmented tooling forms the structural profile into a tee shape; wherein the segmented tooling forms the structural profile into a channel shape; wherein the segmented tooling forms the structural profile into a tubular shape; or wherein the segmented tooling forms the structural profile into a curved shape.

In another example embodiment, a method for the manufacture of a structural profile comprises: providing a plurality of comingled structural fibers; braiding the plurality of comingled structural fibers into a braided preform tube; applying heat to the braided preform tube to melt the braided preform tube; mechanically drawing the braided preform tube into a segmented tooling; applying pressure to the segmented tooling to form and consolidate the braided preform tube into a structural profile; and removing the structural profile from the segmented tooling.

In this embodiment, the method can further comprise: wherein the plurality of comingled structural fibers comprises a plurality of carbon fibers and a plurality of thermoplastic polymer filaments; inserting a pre-pultruded rod into the braided preform tube; securing the braided preform tube in the segmented tooling using at least one drawstring; comprising inserting a zero degree axial tow into the braided preform tube; comprising utilizing a step-molding machine to apply heat to the braided preform tube; wherein the segmented tooling forms the structural profile into a hat-shape; wherein the segmented tooling forms the structural profile into an I-shape; wherein the segmented tooling forms the structural profile into a Pi-shape; wherein the segmented tooling forms the structural profile into a tee shape; wherein the segmented tooling forms the structural profile into a channel shape; wherein the segmented tooling forms the structural profile into a tubular shape; or wherein the segmented tooling forms the structural profile into a curved shape.

In another example embodiment, a structural profile comprises: a thermoplastic composite preform comprising a plurality of carbon fibers, a plurality of thermoplastic polymer filaments, and wherein the plurality of carbon fibers and the plurality of thermoplastic polymer filaments are braided to form a braided preform tube; and wherein the braided preform tube forms the thermoplastic composite structural profile when heated and consolidated by segmented tooling.

In this embodiment, the structural profile can further comprise wherein the braided preform tube further comprises a pultruded rod; wherein the braided preform tube further comprises a zero degree axial tow; wherein the structural profile is hat-shaped; wherein the structural profile is I-shaped; wherein the structural profile is Pi-shaped; wherein the structural profile is tee shaped; wherein the structural profile is channel shaped; wherein the structural profile is tubular; or wherein the structural profile is a curved.

Other objects, features, and advantages of the present invention will become apparent upon consideration of the following detailed description and the accompanying drawings

### BRIEF DESCRIPTION OF THE DRAWINGS

FIG. 1 illustrates a side elevational view of the example embodiment of a commingled tow comprising carbon fiber commingled with thermoplastic polymer filaments.

FIG. 2 illustrates a side elevational view of the example embodiment of a braided preform tube utilizing commingled tow.

FIG. 3 illustrates a cross-sectional view of a flat strip shaped structural profile formed from a braided preform tube.

FIG. 4 illustrates a cross-sectional view of a hat section shaped structural profile formed from a braided preform tube.

FIG. 5 illustrates a side elevational view of an example of a hat section shaped structural profile formed from a braided preform tube.

FIG. 6 illustrates a cross-sectional view of a tee section shaped structural profile formed from a braided preform tube.

FIG. 7 illustrates a cross-sectional view of an I-section shaped structural profile formed from a braided preform tube.

FIG. 8 illustrates a cross-sectional view of a Pi-section shaped structural profile formed from a braided preform tube.

FIG. 9 illustrates a cross-sectional view of a tubular section shaped structural profile formed from a braided preform tube.

FIG. 10 illustrates zero degree axial tows incorporated into the braided preform tube.

FIG. 11 illustrates a cross-sectional view of zero degree axial tow incorporated into the cap of a hat section shaped structural profile.

FIG. 12 illustrates a cross-sectional view of zero degree axial tow incorporated a tubular section shaped structural profile.

FIG. 13 illustrates a cross-sectional view of a molded edge incorporated into a hat section shaped structural profile.

FIG. 14 illustrates a cross-sectional view of a pultruded rod and bead stiffener incorporated into various example structural profile shapes.

FIG. 15 illustrates a cross-sectional view of drawstrings incorporated into various example structural profile shapes.

FIG. 16 illustrates a cross-sectional view of a tee section forming die configured to provide consolidation pressure in two opposed directions with press action in only one direction.

FIG. 17 illustrates an example flow diagram for a heating and forming process of structural profiles of the present invention.

FIG. 18 illustrates an example flow diagram for an alternative heating and forming process of structural profiles of the present invention.

FIG. 19 illustrates a perspective view of an automated step molding machine for use with the heating and forming of the structural profiles of the present invention.

### DETAILED DESCRIPTION OF THE INVENTION

The following is a detailed description of embodiments to illustrate the principles of the invention. The embodiments are provided to illustrate aspects of the invention, but the invention is not limited to any embodiment. The scope of the invention encompasses numerous alternatives, modifications, and equivalents. The scope of the invention is limited only by the claims.

While numerous specific details are set forth in the following description to provide a thorough understanding of the invention, the invention may be practiced according to the claims without some or all of these specific details.

Various embodiments will be described in detail with reference to the accompanying drawings. Wherever possible, the same reference numbers are used throughout the drawings to refer to the same or like parts. References made to particular examples and implementations are for illustrative purposes and are not intended to limit the scope of the claims.

Thermoplastic Composite Braided Preforms

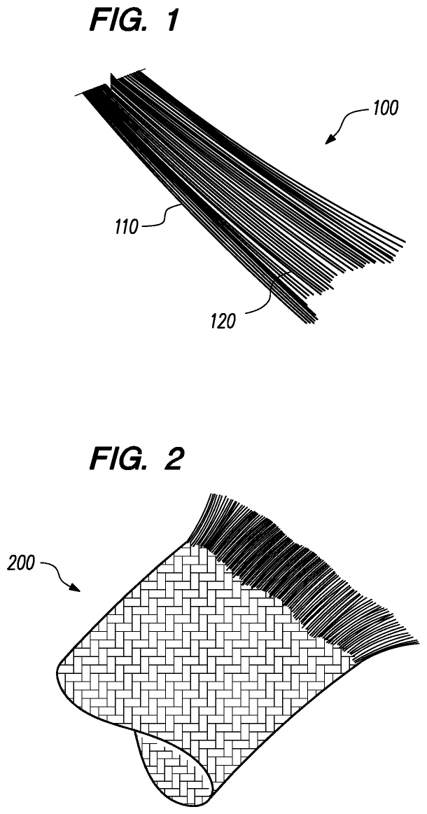

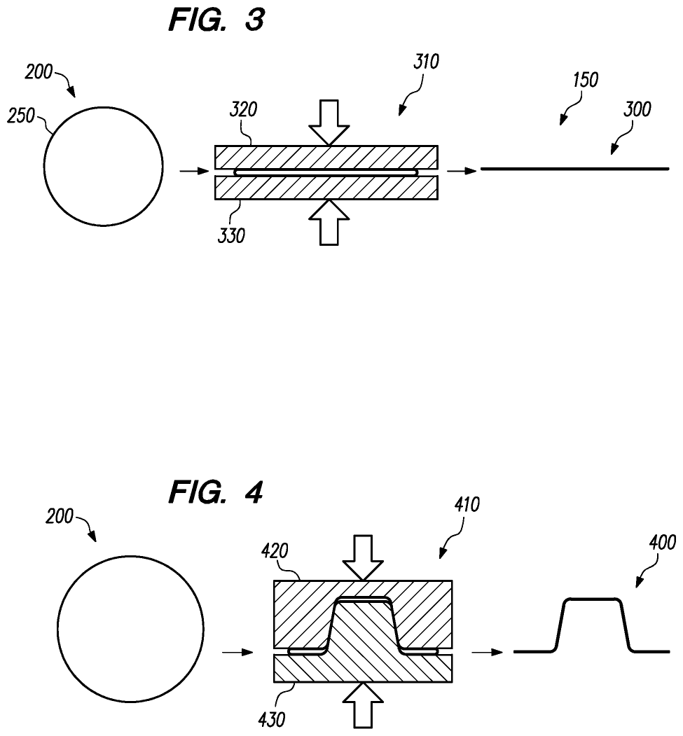

As shown in FIGS. 1 and 2, in an embodiment of this invention, a commingled preform 100 comprises carbon fiber tow 110 commingled with thermoplastic polymer filaments 120. The commingled preform 100 is used for making the braided preform tube 200 as shown in FIG. 2. As shown in FIG. 3, the braided preform tube 200 is used in forming structural profiles 150 that are elongated thermoplastic composites that can be either straight or curved without requiring conventional pre-preg processing to incorporate the resin matrix.

In one embodiment, the commingled preform 100 is a thermoplastic composite structural commingled tow. The carbon fiber tow 110 can be 1K, 3K, 12K, 24K or larger fiber filament counts. The thermoplastic polymer filaments 120 can be engineering thermoplastic filaments such as PPS (polyphenylene sulfide), PEEK (polyetheretherketone), PEI (Polyethylenimine) or other suitable polymers. Thermoplastic polymer filaments 120 are then commingled with carbon fiber tow 110 at the desired fiber-to-resin ratio.

In one embodiment, carbon fiber tow 110 is 12K carbon fiber tow combined with thermoplastic polymer filaments 120 that are PPS thermoplastic filaments at a sixty percent to forty percent (60/40) fiber to matrix filament volume ratio. However, in other embodiments, other fiber sizes and resin ratios can be used to meet end product requirements.

As shown in FIGS. 2 and 3, the commingled preform 100 is used to braid a length of cylindrical braided preform tube 200. The braided preform tube 200 is used to form the structural profiles 150. The flexibility of the braided preform tube 200 to easily align within a curved press forming tool, such as segmented tooling 310, is one key benefit of this invention which is of particular importance when axial reinforcements are introduced in the structural profile 150. Variations in the braid circumference 250 of the braided preform tube 200 and the incorporation of carbon fiber tow 110 which is unidirectional comingled tow in the braiding process can create braided preform tubes 200 suitable to make structural profile 150 with elongated structural shapes with optimized fiber architecture.

Structural Profiles

The braided preform tube 200 is used to form a structural profile 150, which in one example embodiment as shown in FIG. 3 can comprise flat strip 300. The braid circumference 250 of the braided preform tube 200 must be configured to match the structural profile 150. For example, in one embodiment, if a flat strip 300 with a four inch wide flat strip cross section is the structural profile 150 to be made using segmented tooling 310, which acts as a press forming die comprising top section 320 and bottom section 330, then the commingled preform 100, such as carbon fiber tow 110 comprising 12K carbon fiber comingled with thermoplastic polymer filaments 120 comprising PPS tow, would be braided with an approximately 8-inch braid circumference 250. Therefore, when the braided preform tube 200 is flattened, it forms a flat strip 300 with a 4-inch-wide strip of material with two layers. The resultant fiber orientation for this example is 45 degrees relative to the longitudinal axis of the structural profile 150.

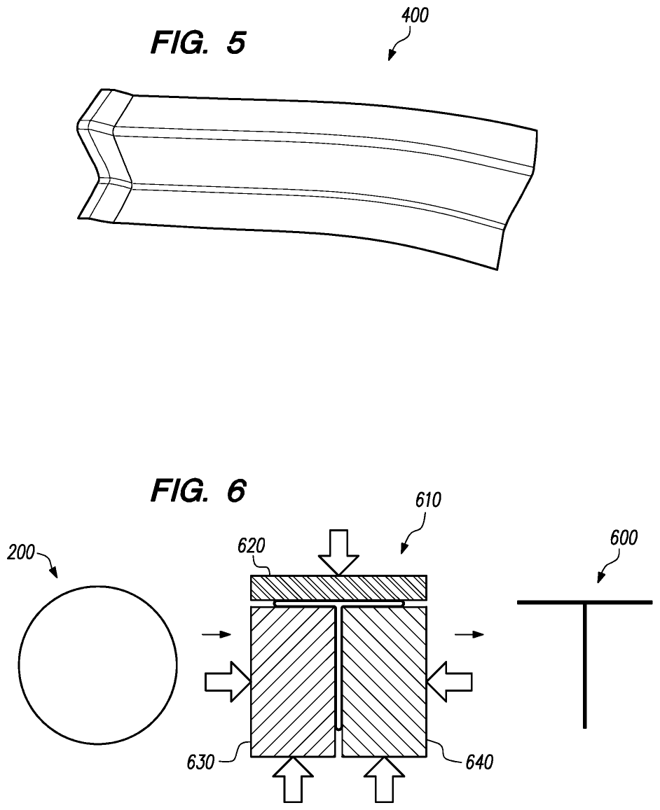

As an alternative embodiment, FIGS. 4 and 5 show a braided preform tube 200 such that when flattened, it has sufficient width to make a structural profile 150 comprising a hat section 400 shape using segmented tooling 410 comprising formed top section 420 and formed bottom section 430.

As another alternative embodiment, FIG. 6 shows an exemplary embodiment wherein the braided preform tube 200 is compressed from multiple directions using segmented tooling 610 to form a structural profile 150 comprising a tee section 600 shape. Segmented tooling 610 comprises top section 620, first side section 630, and second side section 640. Force is applied to the braided preform tube 200 from the top by top section 620, and from the bottom and sides from first side section 630 and second side section 640 to form tee section 600.

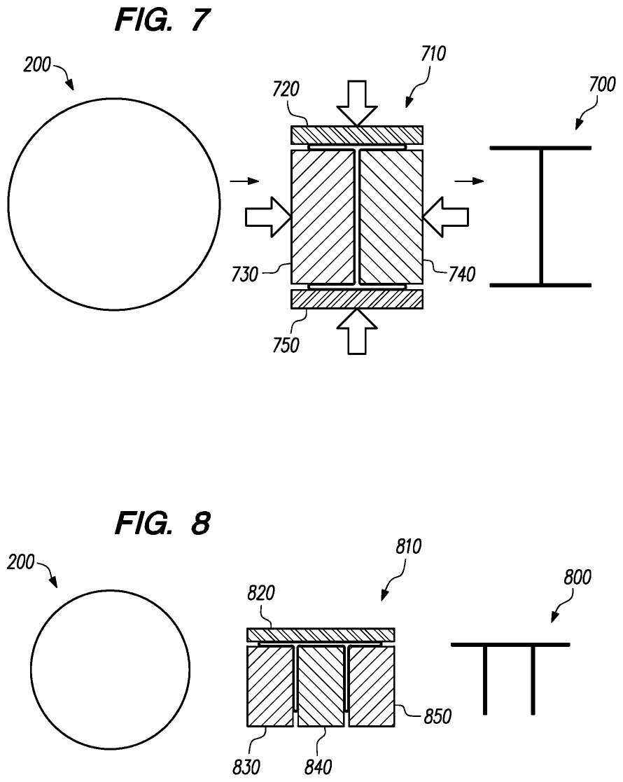

As another alternative embodiment, FIG. 7 shows an exemplary embodiment wherein the braided preform tube 200 is compressed from multiple directions using segmented tooling 710 to form a structural profile 150 comprising an I-section 700 shape. Segmented tooling 710 comprises top section 720, first side section 730, second side section 740, and bottom section 750. Force is applied to the braided preform tube 200 from the top by top section 720, from the bottom by bottom section 750, and from the sides from first side section 730 and second side section 740 to form I-section 700.

As another alternative embodiment, FIG. 8 shows an exemplary embodiment wherein the braided preform tube 200 is compressed from multiple directions using segmented tooling 810 to form a structural profile 150 comprising a Pi-section, or π-section, 800 shape. Segmented tooling 810 comprises top section 820, first bottom section 830, second bottom section 840, and third bottom section 850. Force is applied to the braided preform tube 200 from the top by top section 720, from the bottom by bottom section 840, and from the sides and bottom from first bottom section 830 and third bottom section 850 to form Pi-section 800.

Tubular Profile Sections

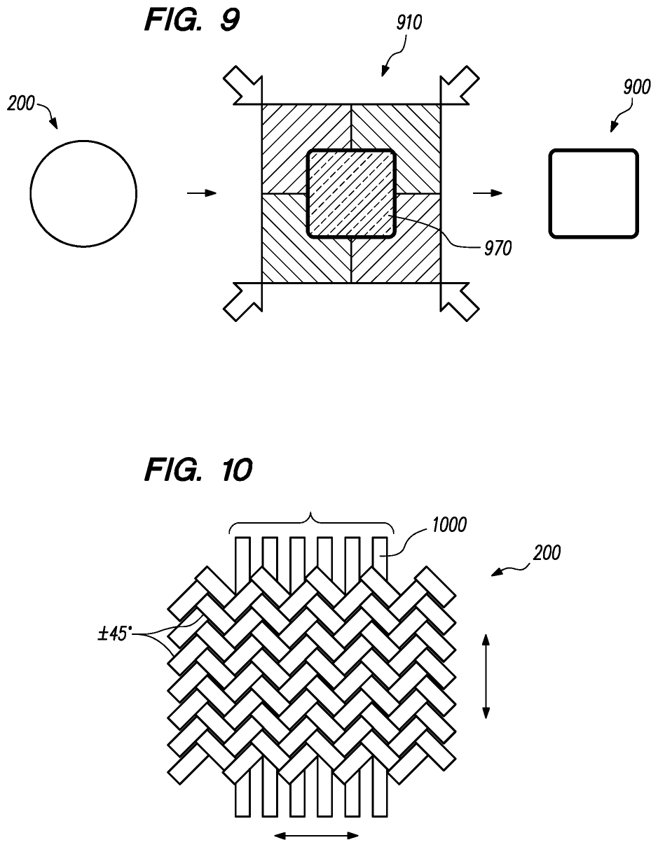

As shown in FIG. 9, and as a further exemplary embodiment, to form a tubular section 900 as the structural profile 150, the braided preform tube 200 can be pulled over a mandrel 970 and pulled tight to cause it to shrink snugly over the mandrel 970. In various embodiments, mandrel 970 can be either round, rectangular, hexagonal or other similar shapes.

Segmented tooling 910 can then be used to compress the braided preform tube 200 against the mandrel 970 while the segmented tooling 910 is heated sufficiently to melt the thermoplastic. The segmented tooling 910 can be segmented as necessary to form the desired shape of the tubular section 900 and apply even pressure and avoid pinching.

As the mandrel 970 cools, it will shrink more than the tubular section 900, allowing the mandrel 970 to be removed from the tubular section 900. In one embodiment, the mandrel 970 is made out of aluminum, which has a relatively high coefficient of thermal expansion, maximizes the difference in shrinkage, and makes the mandrel 970 easier to remove. However, aluminum also has a relatively low melting point, so the mandrel 970 must be tailored with the thermoplastic polymer filaments 120. For example, the high processing temperature of PEEK necessitates a metallic mandrel or tool material like steel to not melt.

Tubular section 900 can only be made straight in order to remove a mandrel 970 when the mandrel 970 is rigid. However, in an alternative embodiment, for a tubular section 900 which is curved, a mandrel 970 which is dissolvable, sometimes called a “wash-out” mandrel, can be used but the material of the mandrel 970 that is selected must withstand the pressure of consolidating the laminate and withstand the heat required. For example, while other suitable materials can also be used, a thermally stable wash out tooling material such as Soltec Solcore HT Tm might be used where it can be cast into complex geometries and can withstand processing temperatures between 400 and 1300 degrees Fahrenheit.

Reinforcement Using Axial Tow

As shown in FIG. 10, the braided preform tube 200 has a 45° fiber orientation. However, in an alternative embodiment, it is also possible to introduce zero-degree axial tow 1000 in the braiding process for either the full circumference of the braided preform tube 200 or a selected portion of the braided preform tube 200. In one embodiment, zero-degree axial tow 1000 can be made using commingled carbon and thermoplastic filament tow or similar materials.

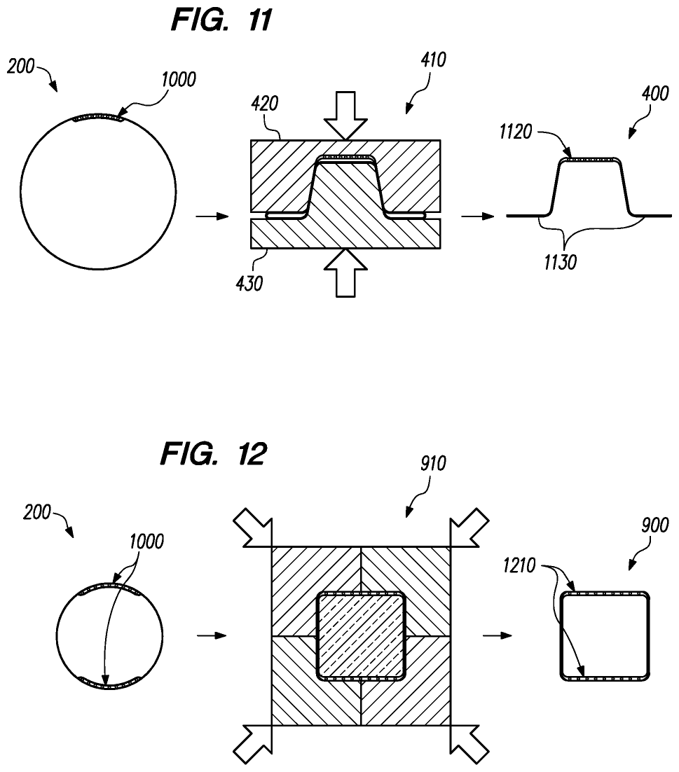

As shown in FIG. 11, and as a further embodiment, in the case of the hat section 400, axial tow 1000 can be incorporated in the braided preform tube 200 in the area of the hat section cap 1120, creating a weight efficient and structurally stronger and stiffer hat section 400. It is also possible to incorporate axial tow 1000 in the two feet areas 1130 of the hat section. Although shown for hat section 400 in FIG. 11, axial tow 1000 can be incorporated into tee section 600, I-section 700, Pi-section 800, or other structural profile 150 shapes to strengthen and stiffen them.

As shown in FIG. 12, and as a further alternative embodiment, axial tow 1000 can also be used to strengthen and stiffen caps 1210 of tubular section 900, which improves performance in bending.

Elimination of Edge Trim

As shown FIG. 13, segmented tooling 410 comprising top section 420 that can include upper step section 1320, and bottom section 430 that can include lower step section 1330 to engage and seal off the braided preform tube 200 before the compression begins to consolidate braided preform tube 200 into structural profile 150. This provides a molded edge 1350 for structural profile 150 with no edge trim required since there are no cut or jagged carbon fibers in the braided preform tube 200, which makes for a clean molded edge 1350 for the structural profile 150 that can be molded without a rough edge or flash.

Although shown for hat section 400 in FIG. 13, this feature can be also used in the various embodiments for flat section 300 using segmented tooling 310, tee section 600 using segmented tooling 610, I-section 700 using segmented tooling 710, Pi-section 800 using segmented tooling 810, and other similar structural profile 150 shapes.

Bead Stiffening Elements

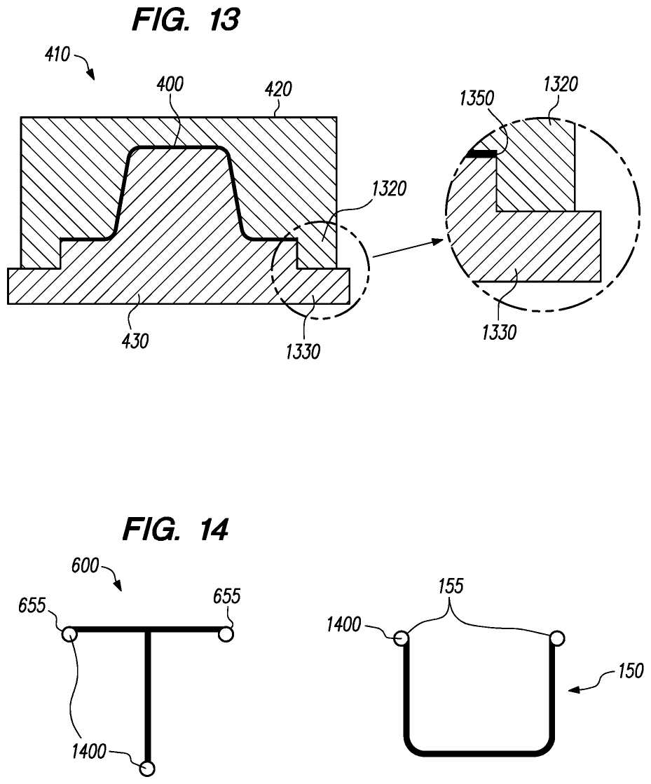

Turning to FIG. 14, as a further alterative embodiment that can be used in combination with other embodiments herein, added structural strength without excessive weight is built into the structural profile 150 by incorporating one or more pultruded rods 1400 into the braided preform tube 200 to stiffen flanges 155 of a structural profile 150 such as flanges 655 of tee section 600. In one embodiment, pultruded rods 1400 can be unidirectional carbon fibers with a co-mingled thermoplastic matrix as a “bead” on the flange 155 of the structural profile 150.

In an alternative embodiment, pultruded rods 1400 can be commingled carbon fiber and PPS tow which can be incorporated in the braided preform tube 200 or put in the braided preform tube 200 as a separate material insert.

In a further embodiment, the pultruded rod 1400 is a unidirectional composite rod which is first pultruded using commingled carbon/PPS or other suitable thermoplastic resin filaments. Once, pultruded, the pultruded rod 1400 is now consolidated and stiff so it is easily inserted into the braided preform tube 200. While the pultruded rod 1400 is stiff enough to be reliably inserted into the braided preform tube 200, it is also flexible enough in bending to make a curved structural profile 150 such as tee section 600.

Although shown for tee section 600 in FIG. 14, pultruded rod 1400 can also be incorporated in the various embodiments into the flanges 155 of I-sections 700, Pi-section 800, hat section 400, or other structural profile 150 shapes for added strength and stiffness. Alternatively, the pultruded rod 1400 can be incorporated into the braiding process of the braided preform tube 200.

Drawstrings

Turning to FIG. 15, to aid in locating the braided preform tube 200 in the segmented tooling 410 and holding it in position while the segmented tooling 410 is closed, and as a further alterative embodiment that can be used in combination with other embodiments herein, a small amount of axial tow can be incorporated into the braided preform tube 200 at appropriate points to use as drawstrings 1500. The braided preform tube 200 is placed in the segmented tooling 410, and as the segmented tooling 410 is closed, the drawstrings 1500 are pulled tight. Typical locations for drawstrings 1500 are at the tips of flanges 155 of structural profile 150 shapes such as tee section 600, Pi-section 800, I-section 700, and hat section 400. The drawstrings 1500 ensure that the flanges 155 extend fully into the spaces provided for them in the segmented tooling 310.

Bi-Directional Consolidation Pressure

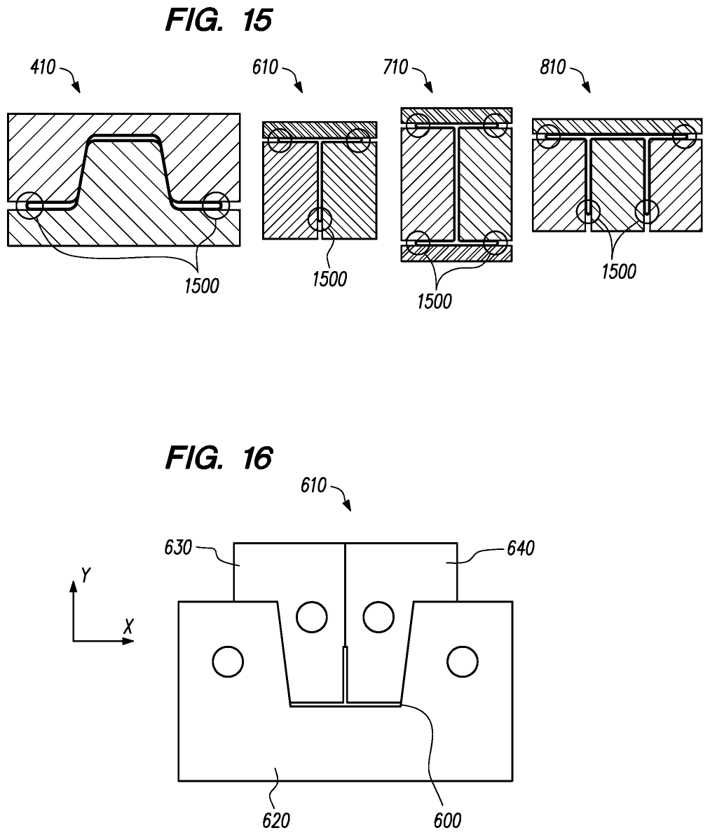

Turing to FIG. 16, for structural profile 150 shapes like the tee section 600, consolidation pressure must be provided in two directions. This can be accomplished with the segmented tooling 610 design by incorporating a wedge action for the segmented tooling 610 components consisting of the top section 620, first side section 630, and second side section 640 creating pressure 90 degrees opposed to the closing direction of the press. Closing the segmented tooling 610 in the vertical axis (y-axis) creates pressure in the horizontal axis (x-axis) thereby consolidating the vertical flange 155 of the structural profile 150. The same wedge tooling principles can be applied on structural profile 150 shapes such as Pi-section 800, I-section 700, and hat section 400.

Heating and Forming Methods for Structural Profiles

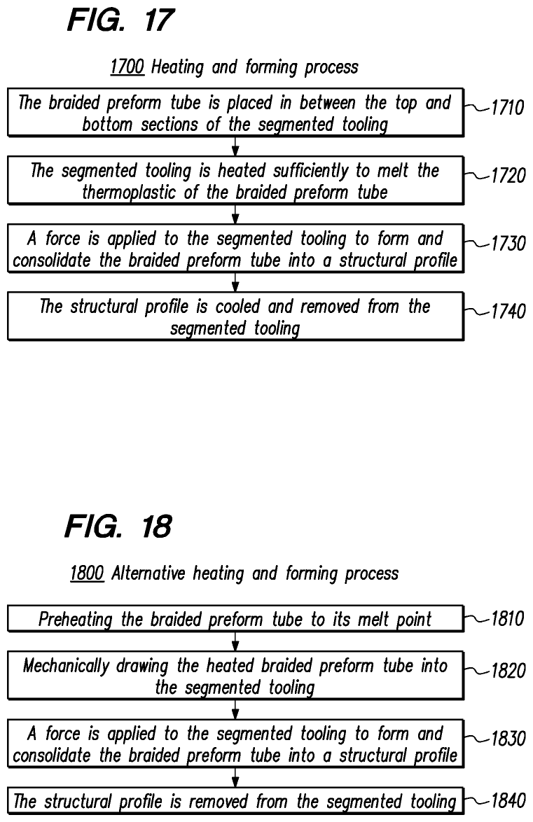

Turning to FIG. 17, the heating and forming process 1700 used to form a structural profile 150 from braided preform tube 200 is shown. In step 1710, the braided preform tube 200 is placed in between segmented tooling 310 comprising top section 320 and bottom section 330. In step 1720, the segmented tooling 310 is then heated sufficiently to melt the braided preform tube 200. Next, in step 1730, a pressure force is applied to the top section 320 and the bottom section 330 of the segmented tooling 310 to form and consolidate the braided preform tube 200 into a structural profile 150 consisting of flat strip 300. In step 1740, the structural profile 150 is then cooled and removed from the segmented tooling 310.

This same heating and forming process 1700 can be also used for hat section 400 using segmented tooling 410, tee section 600 using segmented tooling 610, I-section 700 using segmented tooling 710, Pi-section 800 using segmented tooling 810, and other similar structural profile 150 shapes.

In one embodiment, approximately 280 psi is required to consolidate braided preform tube 200 into a structural profile 150. The processing temperature required to melt and flow the braided preform tube 200 is dependent on the thermoplastic polymer filaments 120. For example, in one embodiment in the case of PPS (polyphenylene sulfide), the melt temperature is approximately 600° F. In other embodiments, thermoplastic polymer filaments 120 such as PEEK (polyetheretherketone) require higher temperatures to melt and flow the thermoplastic polymer filaments 120. Thermoplastic polymer filaments 120 meeting the typical requirements for airframe structures include PEEK, PPS, PEKK, and PEI.

The segmented tooling 310 used to press and form the structural profile 150 must be capable of withstanding the processing conditions, with steel being a preferred choice in one embodiment. In this embodiment, it is feasible to close top section 320 and the bottom section 330 of the segmented tooling 310 directly on a room temperature braided preform tube 200, and then to heat, consolidate, and subsequently cool the braided preform tube 200 to form the structural profile 150.

In an alternative embodiment, as shown in FIG. 18 for alternative hearing and forming process 1800, an improved production rate can be achieved by preheating the braided preform tube 200 using IR (infrared) or induction heating to its melt point in step 1810. In step 1820, the heated braided preform tube 200 is mechanically drawn into the segmented tooling 310 and the top section 320 and the bottom section 330 of the segmented tooling 310 is closed. In step 1830, a pressure force is applied to the segmented tooling 310 to form and consolidate the braided preform tube 200 into a structural profile 150. In step 1840, the segmented tooling 310 is opened and the structural profile 150 is removed from the segmented tooling 310.

With this approach, the segmented tooling 310 can be maintained at roughly 200° F. and the segmented tooling 310 acts like a heat sink when it is closed on the hot braided preform tube 200. Using this approach, it is not necessary to heat the segmented tooling 310 (for example to approximately 600° F. in the case of PPS) and then cool it back down to the point where it is cool enough to remove the structural profile 150.

This same alternative hearing and forming process 1800 can be also used for hat section 400 using segmented tooling 410, tee section 600 using segmented tooling 610, I-section 700 using segmented tooling 710, Pi-section 800 using segmented tooling 810, and other similar structural profile 150 shapes.

Automated Fabrication

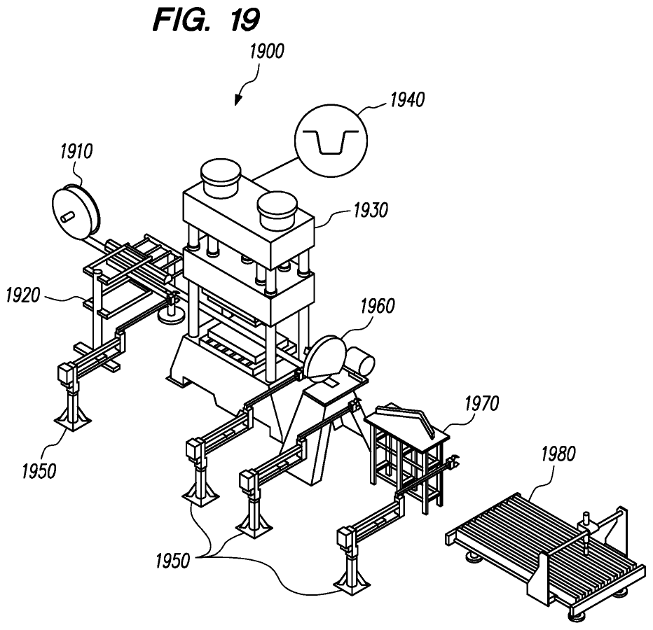

In a further alterative embodiment that can be used in combination with other embodiments herein, creating the braided preform tube 200 with desired fiber orientations for a structural profile 150 allows for automated processing as shown by example in FIG. 19. Preheating the braided preform tube 200 before delivering it to the segmented tooling 310 can be automated as a step-molding process with step molding machine 1900. With step-molding, the structural profile 150 is not cut to length until late in the process, so robotic removal of the structural profile 150 from the segmented tooling 310 draws in new preheated braided preform tube 200 material from the preheat zone, which must be at least as large as the structural profile 150 to be molded.

As shown in FIG. 19, the braided preform tube 200 is introduced to a step molding machine 1900 from material supply roll 1910. The braided preform tube 200 is pre-heated to the melt point of the comingled thermoplastic filaments by heating unit 1920 and then drawn into the press forming station 1930. In one embodiment, a two piece press forming tool 1940, such as segmented tooling 410, is closed onto the hot braided preform tube 200 forming and consolidating the braided preform tube 200 into a usable hat section 400 or other structural profile 150. The structural profile 150 can be straight or curved within the limits of the press forming tool 1740 and the press forming station 1930.

Robotic arms 1950 facilitate transfer of the structural profile 150, including to chop saw 1960 to cut the structural profile 150 to length and cooling table 1970 to allow structural profile 150 to cool. This transfer of the structural profile 150 pulls new portions of braided preform tube 200 off the material supply roll 1910 and into the heating unit 1920. CNC (computer numerical control) trimming machine 1980 can also be used for finishing work.

While the invention has been specifically described in connection with certain specific embodiments thereof, it is to be understood that this is by way of illustration and not of limitation. Reasonable variation and modification are possible within the scope of the foregoing disclosure and drawings without departing from the spirit of the invention.

We claim:

1. A method for the manufacture of a structural profile comprising:
providing a plurality of comingled structural fibers;
braiding the plurality of comingled structural fibers into a braided preform tube;
inserting the braided preform tube into a segmented tooling;
heating the segmented tooling to melt the braided preform tube;
applying pressure to the segmented tooling to form and consolidate the braided preform tube into a structural profile;
cooling the structural profile; and
removing the structural profile from the segmented tooling.

2. The method of claim 1 wherein the plurality of comingled structural fibers comprises a plurality of carbon fibers and a plurality of thermoplastic polymer filaments.

3. The method in claim 1 further comprising inserting a pre-pultruded rod into the braided preform tube.

4. The method in claim 1 further comprising securing the braided preform tube in the segmented tooling using at least one drawstring.

5. The method in claim 1 further comprising inserting a zero degree axial tow into the braided preform tube.

6. The method of claim 1 wherein the segmented tooling forms the structural profile into a hat-shape.

7. The method of claim 1 wherein the segmented tooling forms the structural profile into an I-shape.

8. The method of claim 1 wherein the segmented tooling forms the structural profile into a Pi-shape.

9. The method of claim 1 wherein the segmented tooling forms the structural profile into a tee shape.

10. The method of claim 1 wherein the segmented tooling forms the structural profile into a channel shape.

11. The method of claim 1 wherein the segmented tooling forms the structural profile into a tubular shape.

12. The method of claim 1 wherein the segmented tooling forms the structural profile into a curved shape.

13. A method for the manufacture of a structural profile comprising:
providing a plurality of comingled structural fibers;
braiding the plurality of comingled structural fibers into a braided preform tube;
applying heat to the braided preform tube to melt the braided preform tube;
mechanically drawing the braided preform tube into a segmented tooling;
applying pressure to the segmented tooling to form and consolidate the braided preform tube into a structural profile; and
removing the structural profile from the segmented tooling.

14. The method of claim 13 wherein the plurality of comingled structural fibers comprises a plurality of carbon fibers and a plurality of thermoplastic polymer filaments.

15. The method in claim 13 further comprising inserting a pre-pultruded rod into the braided preform tube.

16. The method in claim 13 further comprising securing the braided preform tube in the segmented tooling using at least one drawstring.

17. The method in claim 13 further comprising inserting a zero degree axial tow into the braided preform tube.

18. The method in claim 13 further comprising utilizing a step molding machine to apply heat to the braided preform tube.

19. The method of claim 13 wherein the segmented tooling forms the structural profile into a hat-shape.

20. The method of claim 13 wherein the segmented tooling forms the structural profile into an I-shape.

21. The method of claim 13 wherein the segmented tooling forms the structural profile into a Pi-shape.

22. The method of claim 13 wherein the segmented tooling forms the structural profile into a tee shape.

23. The method of claim 13 wherein the segmented tooling forms the structural profile into a channel shape.

24. The method of claim 13 wherein the segmented tooling forms the structural profile into a tubular shape.

25. The method of claim 13 wherein the segmented tooling forms the structural profile into a curved shape.

26. A structural profile comprising:
a thermoplastic composite preform comprising:
a plurality of carbon fibers;
a plurality of thermoplastic polymer filaments; and
wherein the plurality of carbon fibers and the plurality of thermoplastic polymer filaments are braided to form a braided preform tube; and
wherein the braided preform tube forms the thermoplastic composite structural profile when heated and consolidated by segmented tooling.

27. The structural profile of claim 26 wherein the braided preform tube further comprises a pultruded rod.

28. The structural profile of claim 26 wherein the braided preform tube further comprises a zero degree axial tow.

29. The structural profile of claim 26 wherein the structural profile is hat-shaped.

30. The structural profile of claim 26 wherein the structural profile is I-shaped.

31. The structural profile of claim 26 wherein the structural profile is Pi-shaped.

32. The structural profile of claim 26 wherein the structural profile is tee shaped.

33. The structural profile of claim 26 wherein the structural profile is channel shaped.

34. The structural profile of claim 26 wherein the structural profile is tubular.

35. The structural profile of claim 26 wherein the structural profile is curved.
